(19) United States
(12) Patent Application Publication
(10) Pub. No.: US 2007/0157016 A1
(43) Pub. Date: Jul. 5, 2007

(54) Apparatus, system, and method for autonomously preserving high-availability network boot services

(76) Inventors: Richard Alan Dayan, Wake Forest, NC (US); Jeffrey Bart Jennings, Raleigh, NC (US); Kofi Kekessie, Durham, NC (US)

Correspondence Address: KUNZLER & ASSOCIATES, 8 EAST BROADWAY, SUITE 600, SALT LAKE CITY, UT, 84111, US

(21) Appl. No.: 11/321,613

(22) Filed: Dec. 29, 2005

(51) Int. Cl. G06F 9/00

(52) U.S. Cl. 713/2

(57) ABSTRACT

An apparatus, system, and method are disclosed for autonomously preserving high-availability network boot services. The apparatus includes a monitor module, a detection module, and a substitution module. The monitor module actively monitors a distributed logical linked list. The detection module detects a variation in a distributed logical linked list configuration. The substitution module substitutes a network boot service of a failed element of the distributed logical linked list. The apparatus, system, and method provide preservation of on-demand network services autonomously, maintaining a high-availability of network boot services.

### BACKGROUND

1. Field of Art

This invention relates to network boot service and more particularly relates to autonomously providing a method to preserve and maintain on-demand network services, while providing high-availability to network bootable system applications.

2. Background Technology

Bootstrapping, or simply booting, is the process of starting up a computer. Bootstrap most commonly refers to the sequence of instructions that actually begins the initialization of the computer's operating system, such as GRUB, or LILO, and initiate the loading of the kernel, such as NTLDR. Furthermore, some computers have the ability to boot over a network.

Network booting, also known as remote booting, means that a computer or client device can boot over a network, such as a local area network (LAN), using files located on a network server. To perform a network boot, the client computer executes firmware, such as a boot ROM, while the boot server is running network boot services (NBS) as is well known to those skilled in the art. When the client computer is powered on, a boot image file is downloaded from the boot server into the client computer's memory and then executed. This boot image file can contain the operating system for the client computer or a pre-operating system (pre-OS) application to perform client management tasks prior to booting the operating system.

Network booting helps reduce the total cost of ownership associated with managing a client computer. Boot failures comprise a large portion of overall computing failures, and can be difficult and time consuming to solve remotely. Additionally, a boot failure may prevent a computer from connecting to a network until the failure is resolved, costly for any business that depends on high-availability of business-critical applications.

Network booting assures that every computer on a network, provided that the computer is so enabled, can connect to the network regardless whether the computer has an operating system, a damaged operating system, unformatted hard drives, or no hard drives. Network booting allows a system administrator to automate client device maintenance tasks such as application and OS deployment onto new computers, virus scanning, and critical file backup and recovery. Network booting also allows a system administrator to boot diskless systems such as thin clients and embedded systems.

There are various network boot protocols, but the specification that is currently the industry standard is the preboot execution environment (PXE) specification, which is part of the wired for management (WfM) specification, an open industry specification to help ensure a consistent level of built-in management features and maintenance functions over a network.

The preboot execution environment (PXE) is a protocol to bootstrap a client computer via a network interface and independent of available data storage devices, such as hard disk drives, and installed operating systems on the client computer. The client computer has network boot firmware installed which communicates with a network boot server to download the boot image file to the client computers memory and then executes the boot image.

The PXE environment, in general, comprises a network boot server on the same broadcast domain as a plurality of client computers, where the network boot server is configured to download a boot image to a requesting client computer. This process of downloading a boot image on a client computer will generally make use of a dynamic host configuration protocol (DHCP) server, the trivial file transfer protocol (TFTP), and PXE services.

DHCP is a client-server networking protocol. A DHCP server provides configuration parameters specific to the DHCP client computer requesting, generally, information required by the client computer to participate on a network using internet protocol (IP.) In a PXE environment, the DHCP server provides the client computer with an IP address.

TFTP is a very simple file transfer protocol, with the functionality of a very basic form of FTP. The TFTP service transfers the boot image file from the network boot server to the client computer. The PXE service supplies the client computer with the filename of the boot image file to be downloaded. PXE services may extend the firmware of the client computer with a set of predefined application programming interfaces (APIs), a set of definitions of the ways one piece of computer software communicates with another.

The boot image downloading process may also make use of the internet protocol (IP), a data-oriented protocol used by source and destination hosts for communicating data across a packet-switched inter-network, the user datagram protocol (UDP), a core protocol of the internet protocol suite, UDP is a minimal message-oriented transport layer protocol, and the universal network device interface (UNDI), a hardware independent driver able to operate all compatible network interfaces, such as a network interface card (NIC).

Network boot services, implemented using protocols and services such as DHCP, PXE, and TFTP are becoming increasingly available. The desire of customers to increase NBS dependency, integration, and on-demand service is growing at a dramatic rate. The need to improve NBS response time and service reliability grows inline with increasing NBS integration and usage. Networks employing NBS are typically composed of multiple clients and a management server, such as the IBM PXE-based remote deployment manager (RDM). With RDM, it is possible to use multiple deployment servers, functioning, as it were, under the control of a management server. These remote deployment servers have no primary network boot management functions, functioning essentially as slaves to the RDM server.

In a managed PXE environment, when new client hardware boots to the network, the client computer typically does so to obtain an operating system image so that the client computer can be used by an end user. The process, in principle, begins when the client computer boots to the network and obtains an IP address from a DHCP server so that the client computer can communicate on the network at the network layer, or level three of the seven layer open systems interconnection (OSI) reference model. This process also provides the client computer with the identity of available boot servers.

Next, the client computer locates a boot server that is connected to, and servicing, the same subnetwork, or subnet, a division of a classful network, to which the client computer is connected. Thus, the client computer may then request further instructions from the boot server. The instructions typically tell the client computer the file path of a requested boot image or network bootstrap program (NBP.) Lastly, the client computer contacts the discovered resources, downloads the NBP into the client computer random access memory (RAM), perhaps via TFTP. The client computer may then verify the NBP, and then proceed to execute the NBP.

This sequence of events is straightforward. However, it does not account for network outages, hardware failures, or software malfunctions. Firstly, if the PXE server for a subnet is unavailable, then no client computer on that subnet can be processed. And if the management server is unavailable, then no client computer on the entire network can be processed.

The invention describes methods by which an NBS environment can be hardened by ensuring that there is no single point of failure. The invention makes the NBS environment redundantly capable so that even in the case where there are many network, hardware, and/or software failures, the services of the NBS environment will remain available. In an on-demand environment, this is critical.

Current technology may provide a similar fault-tolerance using a redundant replica master server. However, at any given time at least one server, typically the redundant replica master server, remains unused. On the other hand, the system and method described is a high-availability solution that incorporates full utilization of all network resources, increasing system efficiency, while not placing a heavy load on network resources in order to maintain the integrity of the network system.

From the foregoing discussion, it should be apparent that a need exists for an apparatus, system, and method that overcome the limitations of conventional network boot services. In particular, such an apparatus, system, and method would beneficially preserve and maintain accessibility to all aspects of a systems network boot services.

### SUMMARY

The several embodiments of the present invention have been developed in response to the present state of the art, and in particular, in response to the problems and needs in the art that have not yet been fully solved by currently available network boot services. Accordingly, the present invention has been developed to provide an apparatus, system, and method for autonomously preserving high-availability network boot services that overcome many or all of the above-discussed shortcomings in the art.

The utility to preserve network service is provided with a logic unit containing a plurality of modules configured to functionally execute the necessary operations for maintaining a network service. These modules in the described embodiments include a monitor module, a detection module, and a substitute module. Further embodiments include a configuration module, a replication module, an activation module, and a promotion module.

The monitor module monitors the distributed logical linked list to ensure an accurate representation of the current logical relationship between a plurality of deployment servers that are members of the distributed logical linked list. In one embodiment, the master deployment server, the primary backup deployment server, and one or more secondary deployment servers are members of the distributed logical linked list.

Active monitoring comprises periodically validating the accuracy of the distributed logical linked list within a predefined heartbeat interval. Additionally, the active monitoring may comprise periodically monitoring the integrity of the network boot services of a deployment server within the predefined heartbeat interval. The heartbeat interval is a period of time in which a deployment server is expected to assert active full-functionality of network boot services on behalf of itself as well as that of the deployment server directly downstream in the distributed logical linked list.

The detection module detects a disparity in the logical associations of the distributed logical linked list. In one embodiment, the detection module may detect a disparity in the logical chain in response to a master deployment server failing, being removed, or otherwise going offline. The detection module may also detect a disparity in the integrity of the logical chain in response to a primary backup deployment server and/or a secondary deployment server failing, being removed, or otherwise going offline. Additionally, the detection module may detect a disparity in the integrity of the logical chain in response to a deployment server being added to the system.

The substitution module, in one embodiment, substitutes the network boot service of a failed deployment server in the distributed logical linked list. In another embodiment, the detection module may send a signal to the substitution module in response to detecting a failed deployment server, or a failed component of a deployment server. The substitution module may then notify the master deployment server to take over the network boot service of the failed deployment server, and maintain network service to the subnet of the failed deployment server. In a further embodiment, the master deployment server may assign the network boot service of the failed deployment server to another actively functioning deployment server. Thus, the integrity of network boot services to all subnets attached to the system is preserved autonomously with little or no system administrator intervention.

The configuration module configures the logical associations of the distributed logical linked list of deployment servers. As described above, the configuration module includes a validation module, an update module, a deletion module, and an acknowledgment module. The configuration module operates according to processes set forth in a preservation of service protocol.

The validation module, in one embodiment, validates the logical associations of the distributed logical linked list. The master deployment server may request a secondary deployment server to validate the contents of a server contact list. The acknowledgement module may then acknowledge the accuracy of the server contact list in response to the validation request. In response to receiving an acknowledgement from each deployment server in the logical chain that each server contact list accurately represents the logical associations of the logical chain, the validation module may validate the contents of the active master table.

In another embodiment, the validation module validates the availability of a deployment server linked in the distributed logical linked list. The master deployment server, via the validation module, may validate the availability of a secondary deployment server to serve network boot services to a subnet on the system. The validation module may also validate the active functionality of individual components of a secondary deployment server, such as a PXE server.

The update module, in one embodiment, updates the logical associations of the distributed logical linked list. The master deployment server, via the update module, may send a master sync pulse to all deployment servers linked in the logical chain. The master sync pulse requests a secondary deployment server to update the server contact list to indicate the originator of the message as the master deployment server. Thus, the master deployment server routinely asserts active control over management resources and the management of the distributed logical linked list. In response to the detection module detecting a discrepancy in the distributed logical linked list, due to a failure or insertion of a deployment server, the update module may send a request to update one or more server contact lists.

A primary backup deployment server may also send a master sync pulse, via the update module, in response to replacing a failed master deployment server. In another embodiment, the update module requests to update the server contact list of a target secondary deployment server to indicate the target as the new primary backup deployment server.

A deletion module, in one embodiment, deletes the logical associations of the distributed logical linked list. The master deployment server, via the deletion module, may send a request to a secondary deployment server linked in the logical chain to delete the contents of the server contact list. For example, in response to adding a secondary deployment server to the network boot service system, the deletion module may request the contents of the server contact list of the previous end-of-chain secondary deployment server be deleted. The update module then updates the server contact lists of both the previous end-of-chain secondary deployment server and the inserted secondary deployment server.

The acknowledgment module, in one embodiment, acknowledges the logical associations of the distributed logical linked list. The acknowledgement module may also acknowledge a request from a master deployment server or other deployment server associated with the logical chain. A secondary deployment server may send a message, via the acknowledgement module, to acknowledge whether the server contact list is updated. In another embodiment, the secondary deployment server may acknowledge the server contact list is not updated. In response to the update module requesting an update of a server contact list, the acknowledgment module may acknowledge the updated server contact list.

The replication module replicates the active management resources and active master table from the master deployment server to the primary backup deployment server. The inactive management resources and the inactive master table are complete copies of the active management resources and the active master table respectively. The active management resources include deployment images, comprising network bootstrap programs and any other network deployable application.

In one embodiment, in response to adding, removing, or replacing a deployment image in the active management resources, the replication module adds, removes, or replaces a replica of the same deployment image in the inactive management resources. In the same way, the replication module replicates the contents of the active master table in real-time with the contents of inactive master table. Thus, at any time, the primary backup deployment server is equipped with a replica of all management resources and capable of performing all the management functions of the current master deployment server.

The activation module, in one embodiment, activates and enables the inactive management resources and the inactive master table of a primary backup deployment server. As described above, the inactive management resources and the inactive master table are replicas of the active management resources and the active master table respectively. Thus, a primary backup deployment server merely activates all management functions and is ready to operate as the new master deployment server the instant it is promoted as the master deployment server.

The promotion module, in one embodiment, promotes a primary backup deployment server to a master deployment server. In another embodiment, the promotion module promotes a secondary deployment server to a primary backup deployment server. In a further embodiment, a system administrator may disable the automatic promotion process. Thus, in response to removing a master deployment server, the primary backup deployment server would not be promoted. The removed master deployment server may then be inserted it the system again as the master deployment server. During the time the master deployment server is removed and the automatic promotion service is disabled, network boot services for the entire system would be offline.

A system of the present invention is also presented to autonomously preserve high-availability network boot services. The system may be embodied in a deployment server, the deployment server configured to execute a preservation of network service process.

In particular, the system, in one embodiment, may include a master deployment server configured to manage the preservation of network service process, a primary backup deployment server coupled to the master deployment server, the primary backup deployment server configured to replicate the management functions of the master deployment server, and a secondary deployment server coupled to the primary backup deployment server, the secondary deployment server configured to serve network boot services to a plurality of connected computer clients.

The system also includes a service preservation utility in communication with the master deployment server, the service preservation utility configured to autonomously process operations to preserve the network boot service and maintain a distributed logical linked list of deployment servers. The preservation utility may include a monitor module configured to actively monitor a distributed logical linked list, a detection module coupled to the monitor module, the detection module configured to detect a variation in a distributed logical linked list configuration and a substitution module in communication with the detection module, the substitution module configured to substitute a network boot service of a failed element of the distributed logical linked list.

In one embodiment, the system may include a preclusion indicator configured to indicate a preclusion of promoting a deployment server as a master deployment server; and a priority indicator configured to indicate a priority to position a deployment server higher or lower in a distributed logical linked list. In another embodiment, the master deployment server may comprise an active master table configured to record all members that are current elements of the distributed logical linked list. Furthermore, the primary backup deployment server may comprise an inactive master table configured to replicate all current elements of the active master table.

In one embodiment, a deployment server may comprise a server contact list configured to record an element directly upstream and an element directly downstream from the deployment server on the distributed logical linked list.

A signal bearing medium is also presented to store a program that, when executed, performs operations to autonomously preserve high-availability network boot services. In one embodiment, the operations include autonomously monitoring a distributed logical linked list, detecting a variation in the distributed logical linked list and substituting a failed element of the distributed logical linked list.

In another embodiment, the operations may include configuring the distributed logical linked list and reconfiguring the distributed logical linked list in response to receiving a signal from the detection module as well as replicating an active management resource associated with a master deployment server.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a network boot service system;

FIG. 2 is a schematic block diagram illustrating one embodiment of a master deployment server;

FIG. 3 is a schematic block diagram illustrating one embodiment of a primary backup deployment server;

FIG. 4 is a schematic block diagram illustrating one embodiment of a secondary deployment server;

FIG. 5 is a schematic block diagram illustrating one embodiment of a service preservation utility;

FIGS. 6a and 6b are a schematic block diagram illustrating one embodiment of a master table data structure;

FIG. 7 is a schematic block diagram illustrating one embodiment of a server contact list data structure;

FIG. 8 is a schematic block diagram illustrating one embodiment of a packet data structure; and

FIGS. 9a, 9b and 9c are a schematic flow chart diagram illustrating one embodiment of a service preservation method.

### DETAILED DESCRIPTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

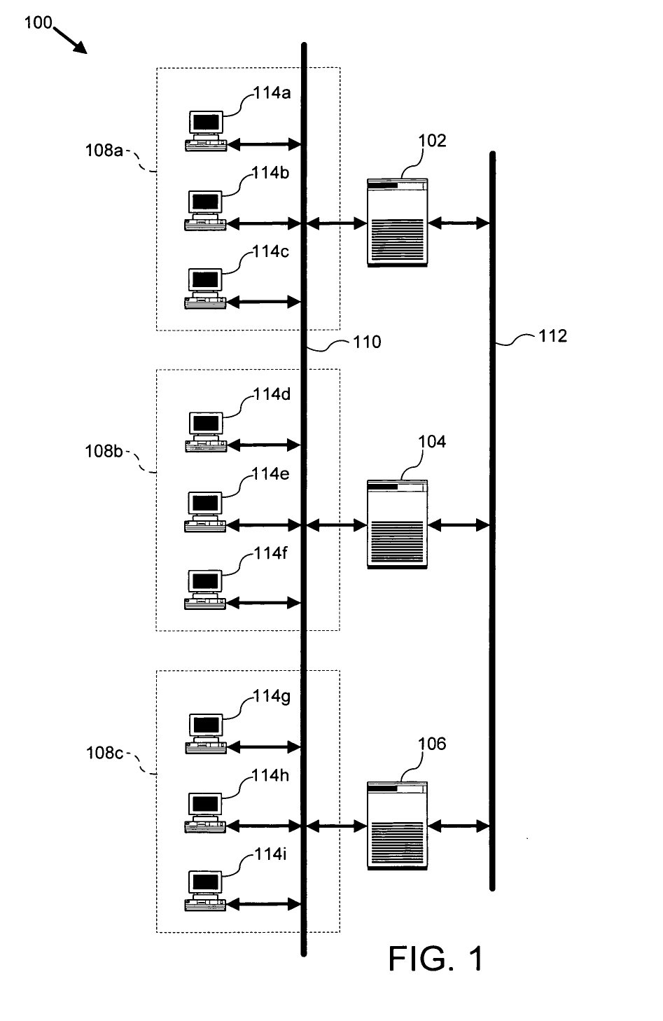

FIG. 1 depicts one embodiment of a network boot service system 100. The system 100 provides network boot services to a plurality of networked clients. The system 100 depicts the physical layout of the deployment servers and clients and their physical connections. The logical layout and logical associations of the deployment servers and clients may vary from the physical layout and physical connections.

The system 100 includes a plurality of deployment servers. Among the plurality of deployment servers may be a master deployment server 102, a primary backup deployment server 104, and a secondary deployment server 106. The system 100 also includes one or more subnets 108, a client network 110, and a server network 112. A subnet 108 includes one or more computer clients 114. The master deployment server 102, the primary backup deployment server 104, and secondary deployment server 106 connect to the plurality of computer clients 114 attached to a subnet 108 via the client network 110. The deployment servers may pass inter-server communications over the server network 112

Although the system 100 is depicted with one master deployment server 102, one primary backup deployment server 104, one secondary deployment server 106, three subnets 108, one client network 110, one server network 112, and three computer clients 114 per subnet 108, any number of master deployment servers 102, primary backup deployment servers 104, secondary deployment servers 106, subnets 108, client networks 110, server networks 112, and computer clients 114 may be employed. Although a deployment server may serve multiple subnets, there may not be more than one deployment server on any single subnet.

The master deployment server 102, the primary backup deployment server 104, and secondary deployment server 106 each serve network bootstrap programs (NBP) to a plurality of client computers 114 connected to the subnet 108 to which each deployment server serves. Each deployment server may serve one or more subnets 108, but each subnet 108 may be served by no more than one deployment server. Currently, when a deployment server fails and goes offline, the entire subnet 108 it serves goes offline as well.

Furthermore, the plurality of client computers 114 comprised within the downed subnet 108 are out of service since all network boot services are unavailable without an active network connection. To prevent a subnet-wide network boot service outage, the master deployment server 102, the primary backup deployment server 104, and secondary deployment server 106 are linked in a distributed logical linked list. In one embodiment, the master deployment server 102 is the topmost, or highest, in the distributed logical linked list. The primary backup deployment server 104 is the second element, directly beneath the master deployment server 102, in the distributed logical linked list. Any other deployment server is logically associated beneath the primary backup deployment server 104.

The distributed logical linked list is managed by the master deployment server 102 and allows the master deployment server 102 to recognize when a deployment server fails. In response to a deployment server failing, the master deployment server 102 takes over the functions and network boot service of the failed deployment server. The master deployment server 102 serves the computer clients 108 attached to the failed deployment server in addition to the computer clients 108 that the master deployment server 102 is already currently serving, if any.

In one embodiment, the master deployment server 102 oversees management functions and resources, and maintains a master list of all members of the distributed logical linked list, in addition to serving network bootstrap programs to the plurality of computer clients 114 attached to the subnet 108 or subnets 108 served by the master deployment server 102. In another embodiment, the primary backup deployment server 104 replicates the management resources of the master deployment server 102 without enabling the management functions, and maintains a replica of the master list of the master deployment server 102.

In one embodiment, the secondary deployment server 106 maintains a list that includes the identification, such as an IP address, of the next deployment server directly upstream and the next deployment server directly downstream in the distributed logical linked list. If a secondary deployment 106 is located at the end of the distributed logical linked list, then the identification of the next deployment server directly downstream is left blank on the list. Like the master deployment server 102, the primary backup deployment server 104 and secondary deployment server 106 serve network bootstrap programs to the plurality of computer clients 114 attached to the subnet 108 or subnets 108 to which they each respectively serve.

The client network 110 and/or server network 112 may communicate traditional block I/O, similar to a storage area network (SAN). The client network 110 and/or server network 112 may also communicate file I/O, such as over a transmission control protocol/internet protocol (TCP/IP) network or similar communication protocol. Alternatively, the deployment servers may be connected directly via a backplane or system bus. In one embodiment, the system 100 comprises two or more client networks 110 and/or two or more server networks 112.

The client network 110 and/or server network 112, in certain embodiments, may be implemented using hypertext transport protocol (HTTP), file transfer protocol (FTP), transmission control protocol/internet protocol (TCP/IP), common internet file system (CIFS), network file system (NFS/NetWFS), small computer system interface (SCSI), internet small computer system interface (iSCSI), serial advanced technology attachment (SATA), integrated drive electronics/advanced technology attachment (IDE/ATA), institute of electrical and electronic engineers standard 1394 (IEEE 1394), universal serial bus (USB), fiber connection (FICON), enterprise systems connection (ESCON), a solid-state memory bus, or any similar interface.

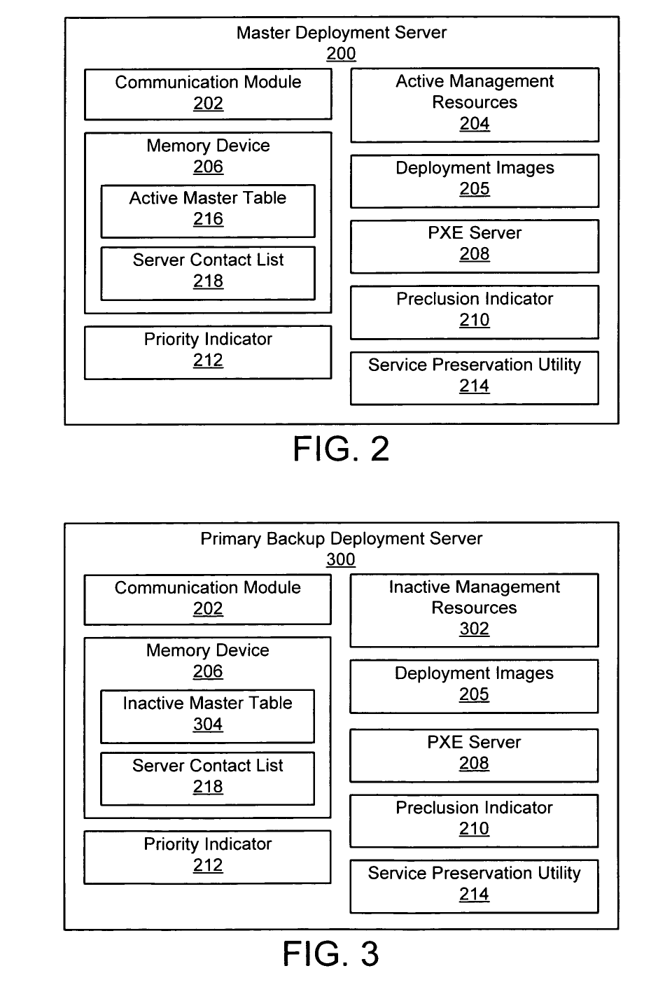

FIG. 2 depicts one embodiment of a master deployment server 200. The master deployment server 200 may be substantially similar to the master deployment server 102 of FIG. 1. The master deployment server 200 includes a communication module 202, active management resources 204, a plurality of deployment images 205, a memory device 206, a PXE server 208, a preclusion indicator 210, a priority indicator 212, and a service preservation utility 214. The memory device 206 includes an active master table 216. In one embodiment, the active management resources 204 may include a plurality of deployment images 205. The master deployment server 200 manages the distributed logical link list of deployment servers. In one embodiment, the master deployment server 200 is at the top of the logical chain. The term “distributed logical linked list” may be used interchangeably with “logical chain,” “logical list” or “logical linked list.”

The communication module 202 may manage inter-server communications between the master deployment server 200 and other deployment servers via the server network 112 and/or client network 110. The communication module 202 may also manage network communications between the master deployment server 200 and the plurality of computer clients 114 via the client network 110. In one embodiment, the communication module 202 sends inter-server message packets in order to query and maintain the accuracy of the distributed logical linked list. In another embodiment, the communication module 202 may be configured to acknowledge a request from a new deployment server to be added to the chain of deployment servers in the distributed logical linked list.

The active management resources 204 comprise programs and applications available for a computer client 114 to request and download. In certain embodiments, the active management resources 204 may also include a plurality of applications to manage and preserve services for the network boot service system 100, and the plurality of deployment images 205. The deployment images 205 may comprise network bootstrap programs and any other network deployed program. In one embodiment, the management resources 204 are active and enabled only in the master deployment server 200.

The illustrated memory device 206 includes an active master table 216. The memory device 206 may act as a buffer (not shown) to increase the I/O performance of the network boot service system 100, as well as store microcode designed for operations of the master deployment server 200. The buffer, or cache, is used to hold the results of recent requests from a client computer 114 and to pre-fetch data that has a high chance of being requested in the near future. The memory device 206 may consist of one or more non-volatile semiconductor devices, such as a flash memory, static random access memory (SRAM), non-volatile random access memory (NVRAM), electrically erasable programmable read-only memory (EEPROM), erasable programmable read only memory (EPROM), NAND/AND, NOR, divided bit-line NOR (DINOR), or any other similar memory device.

The master deployment server 200 maintains the active master table 216. The active master table 216 is a master contact list. The active master table 216 indexes all deployment servers currently members of the distributed logical linked list. The master deployment server 200 maintains the active master table 216 by communicating messages between itself and the distributed logical linked list members. A member of the distributed logical linked list may include any deployment server. The master table 216 indicates that the master deployment server 200 is the active master of the logical chain of deployment servers.

In one embodiment, the master deployment server 200 queries the current status of a member of the logical chain and receives an acknowledgement from the queried member in order to confirm the member is currently active and online. The master deployment server 200 may determine a member of the logical chain is inactive and offline in response to not receiving an acknowledgment or response to a query. In one embodiment, in response to the master deployment server 200 determining a member of the logical chain is inactive and offline, the master deployment server 200 may remove the member from the logical chain and update the active master table 216 to reflect the inoperative member.

The preboot execution environment (PXE) server 208 provides PXE functions from the master deployment server 200. Thus, in addition to overseeing management resources and maintaining the distributed logical linked list, the master deployment server 200 replies to PXE requests from client computers 114 connected to the subnet 108 which the master deployment server 200 serves. Furthermore, the master deployment server 200 provides fault-tolerance to a computer client 114 currently downloading a network bootstrap program. For example, if the PXE server 208 for a particular subnet 108 fails while a computer client 114 is in the middle of downloading the network bootstrap program, the master deployment server 200 may substitute the PXE functions of the failed PXE server 208 and take over network boot service to that particular subnet 108.

The preclusion indicator 210 indicates whether a deployment server is precluded from being a master deployment server 200. In one embodiment, the preclusion indicator 210 may be a binary value. In a further embodiment, the binary value may be determined by a system administrator, where a binary 1 may indicate a preclusion of a deployment server to be a master deployment server 200, and a binary 0 would indicate a permission of a deployment server to be a master deployment server 200. In another embodiment, the preclusion indicator 210 may be determined by the hardware features, software versions, and other similar attributes of a deployment server. In one embodiment, the preclusion indicator 210 of the active master deployment server 200 is locked and may not be changed while the master deployment server 200 remains active and online.

The priority indicator 212 indicates whether a deployment server is more qualified to be a master deployment server 200 compared to another deployment server on the same logical chain. For example, a master deployment server 200 may determine a certain deployment server has less runtime than another deployment server in the logical chain, and therefore less likely to fail. The master deployment server 200 may also determine a deployment server has improved hardware features and/or newer software/firmware versions installed compared to another deployment server in the chain. Thus, the master deployment server 200 may give priority to a certain deployment server in order to ensure the deployment server is placed higher in the logical chain. In one embodiment, should the master deployment server 200 fail, a deployment server that is higher in the logical chain would be promoted to be the master deployment server 200 before a deployment server further down the logical chain.

The priority indicator 212 may be configured to indicate an inserted deployment server is the new master deployment server 200. For example, a system administrator may remove a master deployment server 200 from the logical chain, but want to return the removed master deployment server 200 to the logical chain again as the master deployment server 200. In response to removing the master deployment server 200, the deployment server directly downstream from the master deployment server 200 is promoted as the new master deployment server 200. In one embodiment, when a removed master deployment server 200 is reinserted into the logical chain, the reinserted master deployment server 200 is appended at the end of the chain, the last deployment server in the logical chain. In another embodiment, the reinserted master deployment server 200 overrides the current master deployment server 200 and is added to the logical chain again as the master deployment server 200. The reinserted master deployment server 200 overrides the current master deployment server 200 according to a value of the priority indicator 212. The priority indicator 212 may be encoded as a binary value, or any other similar encoding scheme.

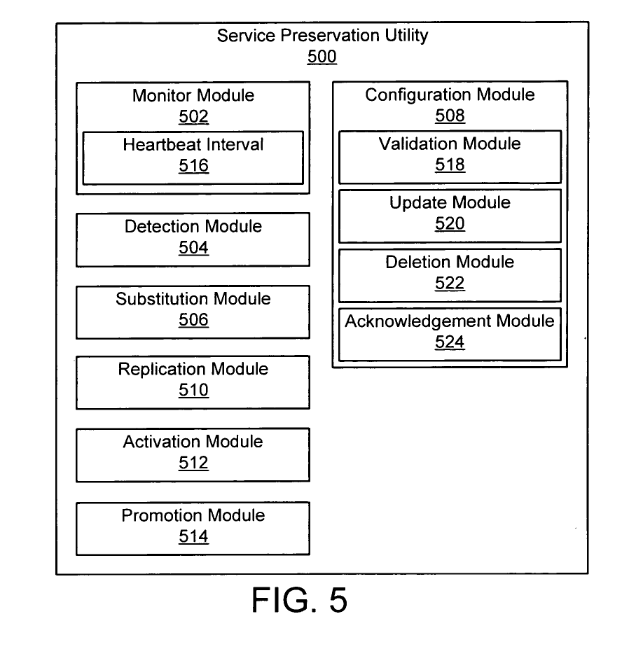

In general, the service preservation utility 214 may implement a preservation of network service process. One example of the service preservation utility 214 is shown and described in more detail with reference to FIG. 5.

The server contact list 218 is a distributed logical link list that stores the identification, such as an IP address, of the next deployment server directly upstream and the next deployment server directly downstream. The server contact list 218 is self-repairing and self-maintaining. In response to an invalidation of the list, such as a deployment server going offline, the broken logical chain is repaired and rerouted around the offline deployment server. Thus, the server contact list 218 is updating with the new logical associations as required and the active master table 216 is updated to reflect the current state of the distributed logical linked list.

In response to a deployment server being inserted to the network system 100, the logical chain is maintained and the inserted deployment server is appended to the end of the logical chain. Thus, in addition to the active master table 216, only the server contact lists 218 of the previous end-of-chain deployment server and the new end-of-chain deployment server require updating. Of course, the inactive master table 304 continually maintains a real-time replica of the all data stored on the active master table 216.

FIG. 3 depicts one embodiment of a primary backup deployment server 300. The primary backup deployment server 300 may be substantially similar to the primary backup deployment server 104 of FIG. 1. The primary backup deployment server 300 includes a communication module 202, a plurality of deployment images 205, a memory device 206, a PXE server 208, a preclusion indicator 210, a priority indicator 212, and a service preservation utility 214 similar to the master deployment server 200 of FIG. 2. In one embodiment, the preclusion indicator 210 of the primary backup deployment server 300 is locked and may not be changed while the primary backup deployment server 300 remains active and online.

The primary backup deployment server 300 may also include inactive management resources 302, an inactivated replica of the active management resources 204. Like the master deployment server 200, the primary backup deployment server 300 may include a plurality of deployment images 205 in response to serving the deployment images 205 to a subnet. In contrast, the memory device 206 of the primary backup deployment server 300 includes an inactive master table 304. The primary backup deployment server 300 is a backup replica of the master deployment server 200. In one embodiment, the primary backup deployment server 300 is the second deployment server in the logical chain, thus directly following the master deployment server 200.

In one embodiment, the management resources 302 and the master table 304 are inactive and disabled in the primary backup deployment server 300. Though the inactive management resources 302 and the inactive master table 304 of the primary backup deployment server 300 are disabled, they are real-time replicas of the active management resources 204 and the active master table 216 of the master deployment server 200. In the event a master deployment server 200 should fail, the primary backup deployment server 300 activates and enables the inactive management resources 302, the inactive master table 304, and all requisite management functions of a master deployment server 200.

In one embodiment, the inactive master table 304 indicates that the primary backup deployment server 300 is the inactive master of the logical chain of deployment servers. Thus, when a primary backup deployment server 300 is promoted as the active master deployment server 200, the inactive master table 304 requires no updating, but already includes an up to date list of all members of the logical chain upon being activated as the active master table 216.

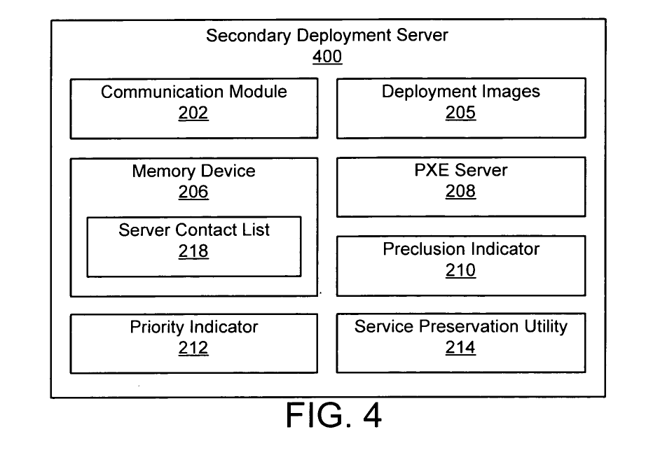

FIG. 4 depicts one embodiment of a secondary deployment server 400. The secondary deployment server 400 may be substantially similar to the secondary deployment server 106 of FIG. 1. The secondary deployment server 400 includes a communication module 202, a memory device 206, a PXE server 208, a preclusion indicator 210, a priority indicator 212, a service preservation utility 214, and a server contact list 218 similar to the master deployment server 200 of FIG. 2 and the primary backup deployment server 300 of FIG. 3.

Unlike the master deployment server 200 and the primary backup deployment server 300, the memory device 206 attached to the secondary deployment server 400 does not include an active master table 216 nor an inactive master table 304. Instead, the memory device 206 on the secondary deployment server 400 includes only the server contact list 218. Neither does the secondary deployment server 400 include any management resources.

FIG. 5 depicts one embodiment of a service preservation utility 500 that may be substantially similar to the service preservation utility 214 of FIG. 2. The service preservation utility 500 preserves a network service in association with a distributed logical linked list. The service preservation utility 500 includes a monitor module 502 that monitors the distributed logical linked list, a detection module 504 that detects variations in the logical setup of the distributed logical linked list, and a substitution module 506 that substitutes the network boot service of a failed member of the distributed logical linked list. A master deployment server 200, a primary backup deployment server 300, and one or more secondary deployment server 400 are members of the distributed logical linked list.

The service preservation utility 500 also includes a configuration module 508 that configures the distributed logical linked list, a replication module 510 that replicates the management resources of a master deployment server 200, an activation module 512 that activates the management resources of a primary backup deployment server 300, and a promotion module 514 that promotes a primary backup deployment server 300 to a master deployment server 200, and/or promotes a secondary backup deployment server 400 to a primary backup deployment server 300. The monitor module 502 includes a heartbeat interval 516 that determines the frequency of the monitor module 502 monitoring the distributed logical linked list.

The configuration module 508 includes a validation module 518 that validates the current logical setup of the distributed logical linked list, an update module 520 that updates the logical setup of the distributed logical linked list, a deletion module 522 that deletes the stored contents of the distributed logical linked list, and an acknowledgement module 524 that acknowledges the current contents of the distributed logical linked list. The service preservation utility 500 may be activated according to a preservation of service protocol. The preservation of service protocol may establish the manner in which the master deployment server 200 may monitor the distributed logical linked list, and the manner in which a loss of network boot service is detected and subsequently substituted and maintained.

As described in FIG. 2, the service preservation utility 500 preserves a pre-configured level of network boot service and maintains a high-availability to network bootstrap programs and other network deployed applications. In response to a deployment server going offline, either planned or unexpected, the service preservation utility 500 preserves the same level of network boot services prior to the deployment server going offline. The service preservation utility 500 provides a network system 100 multiple steps of service preservation, and removes single points of failure within a network infrastructure.

The monitor module 502 monitors the distributed logical linked list to ensure an accurate representation of the current logical relationship between the plurality of deployment servers that are members of the distributed logical linked list. In one embodiment, the master deployment server 200, the primary backup deployment server 300, and one or more secondary deployment servers 400 are members of the distributed logical linked list.

In one embodiment, the master deployment server 200 is continually messaging back and forth with the primary backup deployment server 300 and one or more secondary deployment server 400, much like a communication heartbeat, in order to acknowledge all members of the distributed logical linked list are active and that an active logical link exists between the deployment servers. The logical chain is invalid when a deployment server fails to detect an expected active communication heartbeat from another deployment server within a predefined communication timeout interval. In one embodiment, a deployment server requests a reply from the deployment server directly downstream in the logical chain. In response to receiving a reply, the deployment server notifies the master deployment server 200, and thus the master deployment server 200 validates the contents of active master table 216.

As stated above, active monitoring comprises periodically validating the accuracy of the distributed logical linked list within a predefined heartbeat interval 516. Additionally, the active monitoring may comprise periodically monitoring the integrity of the network boot services of a deployment server within the predefined heartbeat interval 516. The heartbeat interval 516 is a period of time in which a deployment server is expected to assert active full-functionality of network boot services on behalf of itself as well as that of the deployment server directly downstream in the distributed logical linked list.

In the case that the deployment server is the last secondary deployment server 400 in the logical chain, the end-of-chain deployment server asserts active full-functionality of network boot services on behalf of itself only. Thus, every deployment server is validated dependently by itself as well as independently by another deployment server directly upstream. In the case of the master deployment server 200, which has no deployment server directly upstream in the logical chain, the primary backup deployment server 300 and/or any secondary deployment server 400 may validate the master deployment server 200 is online and maintains an active functionality of network boot services.

The detection module 504 detects a disparity in the logical associations of the distributed logical linked list. In one embodiment, the detection module 504 may detect a disparity in the logical chain in response to a master deployment server 200 failing, being removed, or otherwise going offline. The detection module 504 may also detect a disparity in the integrity of the logical chain in response to a primary backup deployment server 300 and/or secondary deployment server 400 failing, being removed, or otherwise going offline. Additionally, the detection module 504 may detect a disparity in the integrity of the logical chain in response to a deployment server being added to the system 100. Lastly, but not inclusively, the detection module 504 may detect a single or individual component or service failure of a deployment server.

In one embodiment, the monitor module 502 and the detection module 504 may be associated with certain protocols for the preservation of network boot services. In response to the detection module 504 failing to detect any disparity in the integrity of the distributed logical linked list, a maintenance protocol may be executed to maintain the integrity of the logical chain. In response to the detection module 504 detecting a deployment server going offline, a recovery protocol may be executed to recover and repair the integrity of the logical chain. In response to the detection module 504 detecting a deployment server being inserted into the system 100, a discovery and insertion protocol may be executed to discover and insert the new deployment server into the logical chain, and modify the logical chain accordingly to reflect the new element of the distributed logical linked list.

The substitution module 506, in one embodiment, substitutes the network boot service of a failed deployment server in the distributed logical linked list. In another embodiment, the detection module 504 may send a signal to the substitution module 506 in response to detecting a failed deployment server, or a failed component of a deployment server. The substitution module 506 may then notify the master deployment server 200 to take over the network boot service of the failed deployment server, and maintain network service to the subnet 108 of the failed deployment server. In a further embodiment, the master deployment server 200 may assign the network boot service of the failed deployment server to another actively functioning deployment server. Thus, the integrity of network boot services to all subnets 108 attached to the system 100 is preserved autonomously with little or no system administrator intervention.

The configuration module 508 configures the logical associations of the distributed logical linked list of deployment servers. As described above, the configuration module 508 includes a validation module 518, an update module 520, a deletion module 522, and an acknowledgment module 524. The configuration module 508 operates according to processes set forth in a preservation of service protocol.

In one embodiment, the deployment servers attached to a network boot service system 100 are equivalent in capabilities and functions, and each provide the same level of network boot services. The deployment servers attached to the system 100 race to be the active master deployment server 200. The configuration module 508 configures the first active deployment server online as the master deployment server 200. The first active deployment server detected by the master deployment server 200 is then configured as the primary backup deployment server 300. All other deployment servers are configured as a secondary deployment server 400.

In one embodiment, a system administrator may assign a priority to a deployment server. The pre-configured priority indicator 212 may determine which deployment server is configured as the master deployment server 200, and the configuration module 508 may then order the remaining deployment servers according to their individual rank of priority. In another embodiment, the configuration module 508 may order a deployment server according to the value of the preclusion indicator 210. In response to the preclusion indicator 210 indicating a deployment server is precluded from being promoted as a master deployment server 200, the configuration module 508 may place the deployment server at the end of the logical chain.

The validation module 518, in one embodiment, validates the logical associations of the distributed logical linked list. The master deployment server 200 may request a secondary deployment server 400 to validate the contents of a server contact list 218. The acknowledgement module 524 may then acknowledge the accuracy of the server contact list 218 in response to the validation request. In response to receiving an acknowledgement from each deployment server in the logical chain that each server contact list 218 accurately represents the logical associations of the logical chain, the validation module 518 may validate the contents of the active master table 216.

In another embodiment, the validation module 518 validates the availability of a deployment server linked in the distributed logical linked list. The master deployment server 200, via the validation module 518, may validate the availability of a secondary deployment server 400 to serve network boot services to a subnet 108 on the system 100. The validation module 518 may also validate the active functionality of individual components of a secondary deployment server 400, such as the PXE server 208.

The update module 520, in one embodiment, updates the logical associations of the distributed logical linked list. The master deployment server 200, via the update module 520, may send a master sync pulse to all deployment servers linked in the logical chain. The master sync pulse requests a secondary deployment server 400 to update the server contact list 218 to indicate the originator of the message as the master deployment server 200. Thus, the master deployment server 200 routinely asserts active control over management resources and the management of the distributed logical linked list. In response to the detection module 504 detecting a discrepancy in the distributed logical linked list, due to a failure or insertion of a deployment server, the update module 520 may send a request to update one or more server contact lists 218.

A primary backup deployment server 300 may also send a master sync pulse, via the update module 520, in response to replacing a failed master deployment server 200. In another embodiment, the update module 520 requests to update the server contact list 218 of a target secondary deployment server 400 to indicate the target as the new primary backup deployment server 300.

A deletion module 522, in one embodiment, deletes the logical associations of the distributed logical linked list. The master deployment server 200, via the deletion module 522, may send a request to a secondary deployment server 400 linked in the logical chain to delete the contents of the server contact list 218. For example, in response to adding a secondary deployment server 400 to the network boot service system 100, the deletion module 522 may request the contents of the server contact list 218 of the previous end-of-chain secondary deployment server 400 be deleted. The update module 520 then updates the server contact lists 218 of both the previous end-of-chain secondary deployment server 400 and the inserted secondary deployment server 400.

The acknowledgment module 524, in one embodiment, acknowledges the logical associations of the distributed logical linked list. The acknowledgement module 524 may also acknowledge a request from a master deployment server 200 or other deployment server associated with the logical chain. A secondary deployment server 400 may send a message, via the acknowledgement module 524, to acknowledge whether the server contact list 218 is updated. In another embodiment, the secondary deployment server 400 may acknowledge the server contact list 218 is not updated. In response to the update module 520 requesting an update of a server contact list 218, the acknowledgment module 520 may acknowledge the updated server contact list 218.

The replication module 510 replicates the active management resources 204 and active master table 216 from the master deployment server 200 to the primary backup deployment server 300. The inactive management resources 302 and the inactive master table 304 are complete copies of the active management resources 204 and the active master table 216 respectively. The active management resources 204 may include deployment images 205, comprising network bootstrap programs and any other network deployable application.

In one embodiment, in response to adding, removing, or replacing a deployment image 205 in the active management resources 204, the replication module 510 adds, removes, or replaces a replica of the same deployment image 205 in the inactive management resources 302. The replication module 510 may also add, remove, or replace a replica of the same deployment images 205 in the secondary deployment servers 400. In the same way, the replication module 510 replicates the contents of the active master table 216 in real-time with the contents of inactive master table 304. Thus, at any time, the primary backup deployment server 300 is equipped with a replica of all management resources and capable of performing all the management functions of the current master deployment server 200.

In another embodiment, in response to a primary backup deployment server 300 replacing a failed master deployment server 200 as the new master deployment server 200, the replication module 510 may be configured to replicate the contents of the active management resources 204 and the active master table 216. The replication module 510 replicates the active management resources 204 and the active master table 216 in a secondary deployment server 400 that replaces the promoted primary backup deployment server 300 as the new primary backup deployment server 300.

The activation module 512, in one embodiment, activates and enables the inactive management resources 302 and the inactive master table 304 of a primary backup deployment server 300. As described above, the inactive management resources 302 and the inactive master table 304 are replicas of the active management resources 204 and the active master table 216 respectively. Thus, a primary backup deployment server 300 merely activates all management functions and is ready to operate as the new master deployment server 200 the instant it is promoted as the master deployment server 200.

In another embodiment, the activation module 512 activates the PXE server 208 of a secondary deployment server 400 added to the distributed logical linked list of deployment servers. The master deployment server 200 may assign a subnet 108 to the newly added secondary deployment server 400 and then activate the network boot services via the activation module 512.

The promotion module 514, in one embodiment, promotes a primary backup deployment server 300 to a master deployment server 200. In another embodiment, the promotion module 514 promotes a secondary deployment server 400 to a primary backup deployment server 300. In a further embodiment, a system administrator may disable the automatic promotion process. Thus, in response to removing a master deployment server 200, the primary backup deployment server 300 would not be promoted. The removed master deployment server 200 may then be inserted it the system 100 again as the master deployment server 200. During the time the master deployment server 200 is removed and the automatic promotion service is disabled, network boot services for the entire system 100 would be offline.

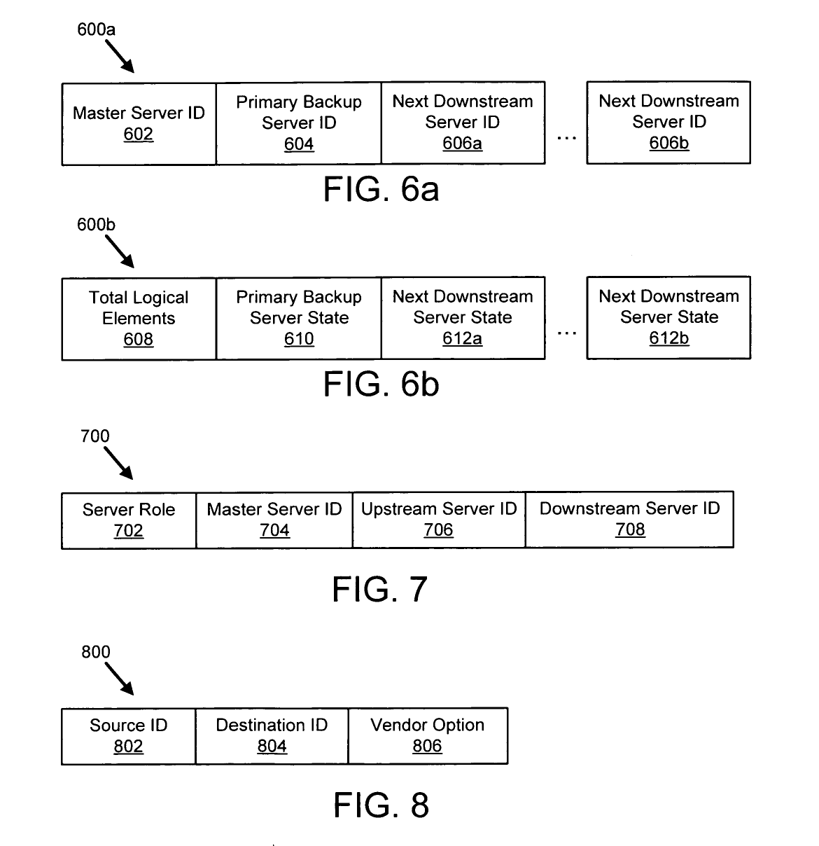

FIGS. 6a and 6b are a schematic block diagram illustrating one embodiment of a master table data structure 600 that may be implemented by the master deployment server 200 of FIG. 2 and/or the primary backup deployment server 300 of FIG. 3. For convenience, the master table data structure 600 is shown in a first part 600a and a second part 600b, but is referred to collectively as the master table data structure 600. The master table data structure 600 is described herein with reference to the network boot service system 100 of FIG. 1.

The master table data structure 600 may include a plurality of fields, each field consisting of a bit or a series of bits. In one embodiment, the master deployment server 200 employs the master table data structure 600 in association with a distributed logical linked list of deployment servers. The master table data structure 600 comprises a plurality of fields that may vary in length. The depicted master table data structure 600 is not an all-inclusive depiction of a master table data structure 600, but depicts some key elements.

The master table data structure 600a may include a master server ID 602, a primary backup server ID 604, and one or more next downstream server IDs 606. The master table data structure 600b may include the following fields: total logical elements 608, primary backup server state 610, and one or more next downstream server state 612.

The master server ID 602 indicates the identification of the current master deployment server 200. In one embodiment, the identification of a deployment server comprises an internet protocol (IP) address assigned to the specific deployment server. The primary backup server ID 604 indicates the identification of the current primary backup deployment server 300. The next downstream server ID 606 indicates the identification of the secondary deployment server 400 logically associated directly beneath the primary backup deployment server 300 in the logical chain. A separate field of the next downstream server ID 606 is included in the master table data structure 600 from the first secondary deployment server 400 logically associated under the primary backup deployment server 300 down to the end-of-chain secondary deployment server 400 at the bottom of the logical chain.

As described previously, the primary backup deployment server 300 maintains a copy of the active master table 216 with one exception. The master server ID 602 is modified to indicate the identification of the primary backup deployment server 300. In other words, the master server ID 602 is removed from the master table data structure 600, and thus, the primary backup server ID 604 is in the position of the master server ID 602, indicating the primary backup deployment server 300 as master deployment server 200. Therefore, after the primary backup deployment server 300 is promoted to be the master deployment server 200, the inactive master table 304 is immediately valid, and becomes the active master table 216 upon promotion. The promoted master deployment server 200 (former primary backup deployment server 300) then promotes the next available downstream secondary deployment server 400 as the new primary backup deployment server 300 and the replication module 510 initiates replication of active management resources 204.

The total logical elements 608 field indicates the total number of deployment servers logically associated with the distributed logical linked list. In one embodiment, the stored value of total logical elements 608 excludes the master deployment server 200, therefore, may vary from 0 to n. In response to the master deployment server 200 being the only deployment server, the total logical elements 608 field stores the value “0.” Thus a stored value of “0” indicates there is no primary backup deployment server 300. A stored value of “1” indicates there is a primary backup deployment server 300 but no secondary deployment server 400. A stored value of “2” indicates that there is a primary backup deployment server 300 and one secondary deployment server 400. A stored value of “3” or more, up to n, indicates that there are two or more, up to n−1, secondary deployment servers 400 logically linked.

The primary backup server state 610 field indicates the current operational state of the primary backup deployment server 300. In one embodiment, the primary backup server state 610 field may comprise a Boolean logic one byte cumulative bit-wise value, where bit0 indicates the response of the primary backup deployment server 300 to a heartbeat signal from the master deployment server 200. Additionally, with respect to the primary backup deployment server 300, bit1 and bit2 may indicate the response of the next deployment server upstream and downstream respectively.

In one embodiment, bit0 set to “0” may indicate the primary backup deployment server 300 is online with full functionality, and bit0 set to “1” may indicate the primary backup deployment server 300 failed to respond to the heartbeat signal from the master deployment server 200. In a further embodiment, bit1 and/or bit2 set to “1” may indicate the upstream deployment server and/or the downstream deployment server report the primary backup deployment server 300 offline. Whereas bit1 and/or bit2 set to “0” may indicate the upstream deployment server and/or the downstream deployment server report the primary backup deployment server 300 online.

The next downstream server state 612 field indicates the current operational state of the secondary deployment server 400 directly downstream from the primary backup deployment server 300, and so on as more secondary deployment servers 400 are added to the system 100. Similar to the primary backup server state 610, the next downstream server state 612 field may comprise a Boolean logic one byte cumulative bit-wise value, where bit0 indicates the response of the secondary deployment server 400 to a heartbeat signal from the master deployment server 200. Additionally, with respect to the secondary deployment server 400, bit1 and bit2 may indicate the response of the next deployment server upstream and downstream respectively.

In one embodiment, bit0 set to “0” may indicate the secondary deployment server 400 is online with full functionality, and bit0 set to “1” may indicate the secondary deployment server 400 failed to respond to the heartbeat signal from the master deployment server 200. In a further embodiment, bit1 and/or bit2 set to “1” may indicate the upstream deployment server and/or the downstream deployment server report the secondary deployment server 400 offline. Whereas bit1 and/or bit2 set to “0” may indicate the upstream deployment server and/or the downstream deployment server report the secondary deployment server 400 online.

FIG. 7 depicts one embodiment of a server contact list data structure 700 associated with a secondary deployment server 400. The server contact list data structure 700 may include a plurality of fields, each field consisting of a bit or a series of bits. In one embodiment, the secondary deployment server 400 employs the server contact list data structure 700 in association with a distributed logical linked list of deployment servers. The server contact list data structure 700 comprises a plurality of fields that may vary in length. The depicted server contact list data structure 700 is not an all-inclusive depiction of a server contact list data structure 700, but depicts some key elements. The server contact list data structure 700 includes a server role 702, a master server ID 704, an upstream server ID 706, and a downstream server ID 708.

The server role 702 indicates the role of the owner or holder of the server contact list data structure 700. In one embodiment, the server role 702 may be a hexadecimal value, or other similar encoding, with a range from x00 to x0F. For example, a 0 (x00) may indicate the owner of the server contact list data structure 700 is the master deployment server 200, and a 1 (x01) may indicate the owner of the server contact list data structure 700 is the primary backup deployment server 300. A value of 2 (x02) may indicate a valid secondary deployment server 400. The server role 702 may also work in conjunction with the preclusion indicator 210 of FIG. 2, where a 15 (x0F) may indicate the associated deployment server is precluded from being promoted to a master deployment server 200.

The master server ID 704 indicates the identification of the current master deployment server 200. Similar to the master table data structure 600, the identification of a deployment server may comprise an internet protocol (IP) address assigned to the specific deployment server. The upstream server ID 706 indicates the identification of a deployment server logically associated directly upstream in the distributed logical linked list. The downstream server ID 708 indicates the identification of a deployment server logically associated directly downstream in the distributed logical linked list.

FIG. 8 depicts one embodiment of a message packet data structure 800 associated with a master deployment server 200, a primary backup deployment server 300 and/or a secondary deployment server 400. The message packet data structure 800 may include a plurality of fields, each field consisting of a bit or a series of bits. In one embodiment, the master deployment server 200 employs the message packet data structure 800 to send a message to another deployment server. The message packet data structure 800 comprises a plurality of fields that may vary in length. The depicted message packet data structure 800 is not an all-inclusive depiction of a message packet data structure 800, but depicts some key elements. The message packet data structure 800 includes a source ID 802, a destination ID 804, and a vendor option 806.

The source ID 802 indicates the identification of the originator of the message packet. Similar to the master table data structure 600, the identification of a deployment server may comprise an internet protocol (IP) address assigned to the specific deployment server. The destination ID 804 indicates the identification of the target of the message packet. The vendor option 806 indicates the definition of the message packet. In other words, the vendor option 806 is a message packet descriptor. The PXE protocol uses a vendor option tag, “option 60,” to differentiate a PXE response from a standard DHCP response. The vendor option 806 gives further definition to a PXE message packet, and is used in conjunction with the existing “option 60” vendor option tag.

In one embodiment, the vendor option 806 may be used in conjunction with the validation module 518 to indicate the message packet as a request to validate a server contact list 218. In another embodiment, the vendor option 806 may be used in conjunction with the update module 520 to indicate a message packet as a request to update a server contact list 218. In a further embodiment, the vendor option 806 may be used in conjunction with the acknowledgment module 524 to indicate a message packet as an acknowledgement that a server contact list 218 is updated. Thus, the vendor option 806 may be used in conjunction with all communications and messages heretofore described, including messages associated with the discovery and insertion protocol, the maintenance protocol, the recovery protocol, and any other protocol associated with the preservation of network boot services on the system 100.

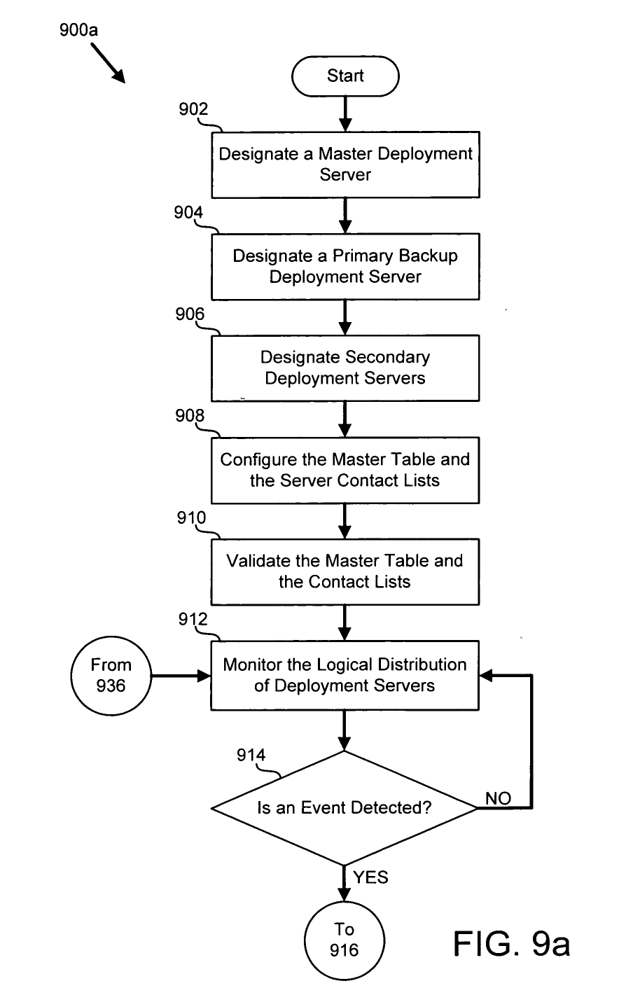

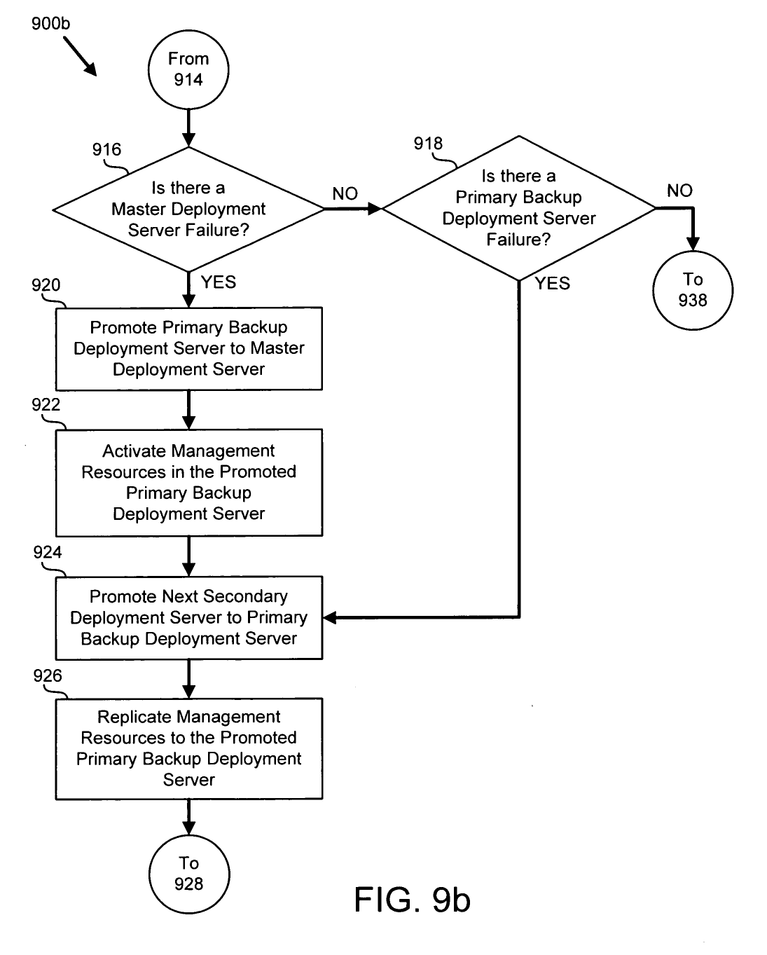

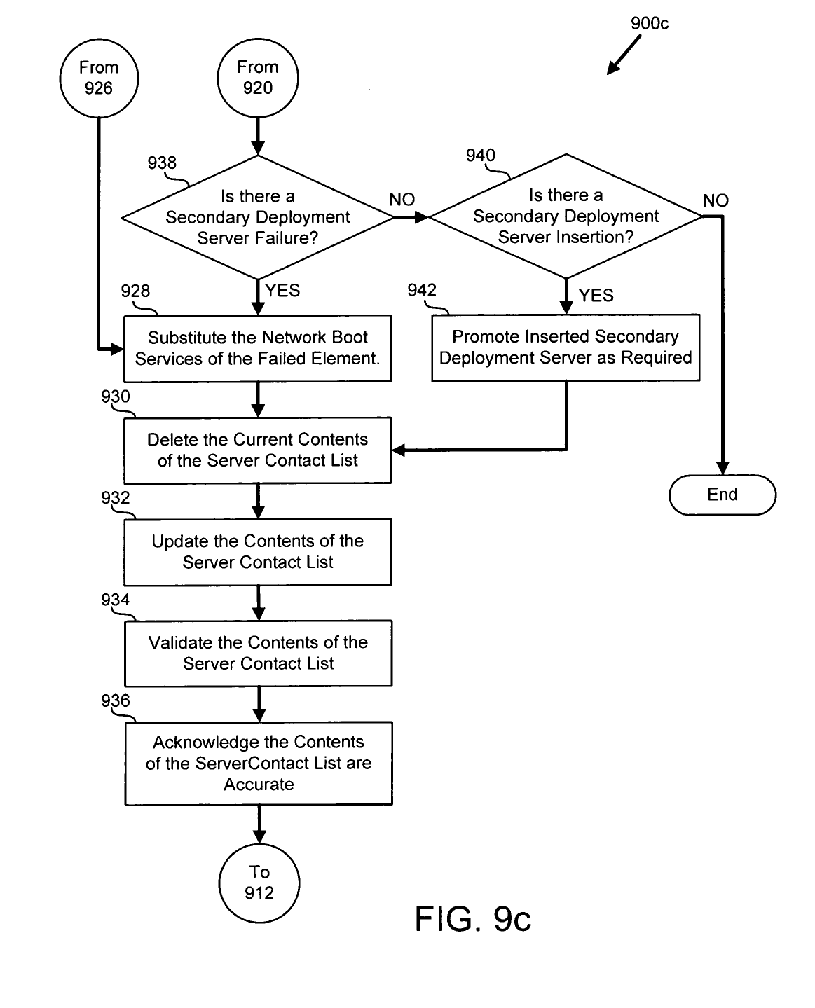

FIGS. 9a, 9b and 9c depict a schematic flow chart diagram illustrating one embodiment of a service preservation method 900 that may be implemented by the service preservation utility 500 of FIG. 5. For convenience, the service preservation method 900 is shown in a first part 900a, a second part 900b and a third part 900c, but is referred to collectively as the service preservation method 900. The service preservation method 900 is described herein with reference to the network boot service system 100 of FIG. 1.

The service preservation method 900a includes operations to designate 902 a master deployment server 200, designate 904 a primary backup deployment server 300, designate 906 one or more secondary deployment servers 400, configure 908 the active master table 216, the inactive master table 304, and the server contact lists 218, validate 910 the active master table 216 and any server contacts lists 218, monitor 912 the logical distribution of deployment servers and determine 914 whether an event is detected.

The service preservation method 900b includes operations to determine 916 whether a detected event is a master deployment server 200 failure, determine 918 whether a detected event is a primary backup deployment server 300 failure, promote 920 the primary backup deployment server 300 to a master deployment server 200, activate 922 the inactive management resources 302 in the primary backup deployment server 300 promoted to a backup deployment server 200, promote 924 the next available secondary deployment server 400 downstream from the new master deployment server 200 to be the new primary backup deployment server 300 and replicate 926 the management resources of the new master deployment server 200 to the new primary backup deployment server 300.

The service preservation method 900c includes operations to determine 938 whether a detected event is a secondary deployment server 400 failure, determine 940 whether a detected event is a secondary deployment server 400 insertion and promote 942 an inserted secondary deployment server 400 as required. The service preservation method 900c also includes operations to substitute 928 the network boot services of a failed deployment server, delete 930 the current contents of the contact list, update 932 the contents of the server contact list 218, validate 934 the contents of the server contact list 218, and acknowledge 936 the contents of the server contact list 218 are accurate.

The service preservation method 900 initiates the service preservation abilities of the service preservation apparatus 500 associated with a master deployment server 200, a primary deployment server 300 and/or a secondary deployment server 400. Although the service preservation method 900 is depicted in a certain sequential order, for purposes of clarity, the network boot service system 100 may perform the operations in parallel and/or not necessarily in the depicted order.

The service preservation method 900 starts and the configuration module 508 designates 902 a master deployment server 200, and thus begins to build the distributed logical linked list of deployment servers. The master deployment server 200 is the topmost node of the distributed logical linked list. In one embodiment, the configuration module 508 designates 902 the first available deployment server online as the master deployment server 200. In another embodiment, a system administrator may designate 902 the master deployment server 200.

Next, the configuration module 508 designates 904 a primary backup deployment server 300. In one embodiment, the configuration module 508 designates 904 the second available deployment server online as the primary backup deployment server 300. The primary backup deployment server 300 is the second node of the distributed logical linked list. The configuration module 508 may designate 904 the first deployment server to contact the master deployment server 200 as the primary backup deployment server 300. In another embodiment, a system administrator may designate 904 the primary backup deployment server 300.

Next, the configuration module 508 designates 906 one or more secondary deployment server 400 as required. In one embodiment, the configuration module 508 designates 906 all other deployment servers after the master deployment server 200 and the primary backup deployment server 300 as secondary deployment servers 400. All secondary deployment servers 400 are nodes logically associated below the master deployment server 200 and the primary backup deployment server 300 in the distributed logical linked list. In another embodiment, a system administrator may designate 906 the secondary deployment servers 400. In a further embodiment, a system administrator may place the secondary deployment servers 400 in a specific order based on individual device attributes, such as a preclusion indicator 210 that precludes the configuration module 508 from designating the associated deployment server as a master deployment server 200.

Following the designation of deployment servers, the configuration module 508 configures 908 the active master table 216 of the master deployment server 200. The configuration module 508 may signal the replication module 510 to copy the active master table 216 into the inactive master table 304. Additionally, the configuration module 508 may configure 908 the server contact lists 218 of the respective deployment servers. The validation module 518 may then validate 910 the active master table 216 and any server contact list 218.

Following validation, the monitor module 502 is initialized and begins to monitor 912 the logical associations of deployment servers in the distributed logical linked list. Next, the detection module 504 determines 914 whether an event occurs. An event may include a failing deployment server, removing a deployment server from the system 100, or adding a deployment server to the system 100 among other potential events associated with a discrepancy in the distributed logical linked list, or other system events. If the detection module 504 does not detect an event within a preconfigured interval, such as the heartbeat interval 516, than the service preservation method 900 continues to monitor 912 the integrity of the distributed logical linked list via the monitor module 502.

Consequently, if the detection module 504 detects an event, then the detection module 504 may determine 916 whether the detected event is due to a master deployment server 200 failure. In one embodiment, the detection module 504 may establish what causes an event in conjunction with the validation module 518. If the detection module 504 does not determine 916 that a failed master deployment server 200 triggered the event, then the detection module 504 may determine 918 whether the detected event is due to a primary backup deployment server 300 failure.

If the detection module 504 does determine 916 that a failed master deployment server 200 triggered the event, the promotion module 514 then promotes 920 the primary backup deployment server 300 to be the new master deployment server 200. Next, the activation module 512 activates 922 and enables the inactive management resources 302 of the promoted primary deployment server 300. The activation module 512 may also activate 922 the inactive master table 304 to be the active master table 216.

Next, the promotion module 514 then promotes 924 the next available secondary deployment server 400 as the new primary backup deployment server 300. The promotion module 514 promotes 924 the next eligible secondary deployment server 400 logically associated directly downstream from the new master deployment server 200. A secondary deployment server 400 is eligible for promotion as long as the preclusion indicator 210 does not preclude the secondary deployment server 400 from promotion.

Following promotion, the replication module 510 replicates 926 the active management resources 204 of the master deployment server 200 to the inactive management resources 302 of the new primary backup deployment server 300. The replication module 510 may also replicate 926 the active master table 216 of the master deployment server 200 to the inactive master table 304 of the new primary backup deployment server 300

Next, the substitution module 506 substitutes 928 the network boot services of the failed deployment server, in this case, the master deployment server 200. The new master deployment server 200 may take over the network boot services of the failed deployment server or may assign the network boot services to another deployment server in the logical chain. The deletion module 522 then deletes 930 the current contents of affected server contact lists 218, or requests any deployment server affected by the failed deployment server to delete 930 the server contact list 218. Generally, a failed deployment server affects the server contact list 218 of the deployment server located logically directly upstream and/or directly downstream from the failed deployment server.

The update module 520 then updates 932 the contents of the affected server contact lists 218. Next, the validation module 518 validates 934 the updated contents of the affected server contact lists 218. Following validation, the acknowledgement module 524 acknowledges 936 the server contact list 218 is updated and validated. The service preservation method 900 then returns to monitor 912 the integrity of the distributed logical linked list and the state of the associated deployment servers.

If the detection module 504 determines 918 that the detected event is due to a primary backup deployment server 300 failure, the promotion module 514 then promotes 924 the next eligible secondary deployment server 400 downstream in the logical chain as the new primary backup deployment server 300. The replication module 510 then replicates 926 the active management resources 204 of the master deployment server 200 to the inactive management resources 302 of the new primary backup deployment server 300.

The substitution module 506 then substitutes 928 the network boot services of the failed deployment server, in this case, the primary backup deployment server 300. Next, the deletion module 522 deletes 930 the current contents of any affected server contact list 218, or requests any deployment server affected by the failed deployment server to delete 930 their server contact list 218.

The update module 520 then updates 932 the contents of the affected server contact lists 218. Next, the validation module 518 validates 934 the updated contents of the affected server contact lists 218. Following validation, the acknowledgement module 524 acknowledges 936 the server contact list 218 is updated and validated. The service preservation method 900 then returns to monitor 912 the integrity of the distributed logical linked list and the state of the associated deployment servers.

If the detection module 504 determines 918 that the detected event is not due to a primary backup deployment server 300 failure, then the detection module 504 determines 938 whether the detected event is due to a secondary deployment server 400 failure. If the detection module 504 determines 938 that the detected event is not due to a secondary deployment server 400 failure, then the detection module 504 determines 940 whether the detected event is due to a secondary deployment server 400 insertion.

If the detection module 504 determines 938 that the detected event is due to a secondary deployment server 400 failure, then the substitution module 506 substitutes 928 the network boot services of the failed deployment server, in this case, a secondary deployment server 400. Next, the deletion module 522 deletes 930 the current contents of any affected server contact list 218, or requests any deployment server affected by the failed deployment server to delete 930 their server contact list 218.

The update module 520 then updates 932 the contents of the affected server contact lists 218. Next, the validation module 518 validates 934 the updated contents of the affected server contact lists 218. Following validation, the acknowledgement module 524 acknowledges 936 the server contact list 218 is updated and validated. The service preservation method 900 then returns to monitor 912 the integrity of the distributed logical linked list and the state of the associated deployment servers.

If the detection module 504 determines 940 that the detected event is not due to a secondary deployment server 400 insertion, then the service preservation method 900 ends. In one embodiment, the service preservation method 900 notifies the system administrator that the detection module 504 has detected an unknown event. In another embodiment, the service preservation method 900 may return to monitor 912 the integrity of the distributed logical linked list. Alternatively, the service preservation method 900 may include additional defined events and continue to deduce the cause of the triggered event.

If the detection module 504 determines 940 that the detected event is due to a secondary deployment server 400 insertion, then the promotion module 514 may promote 942 the inserted secondary deployment server 400 as required. For example, a system administrator may give the inserted secondary deployment server 400 a priority, in indicated by the priority indicator 212, over other secondary deployment servers 400 already logically linked in the logical chain.

Next, the deletion module 522 deletes 930 the current contents of any affected server contact list 218, or requests any deployment server affected by the failed deployment server to delete 930 their server contact list 218. The update module 520 then updates 932 the contents of the affected server contact lists 218.

Following the update, the validation module 518 validates 934 the updated contents of the affected server contact lists 218. Following validation, the acknowledgement module 524 acknowledges 936 the server contact list 218 is updated and validated. The service preservation method 900 then returns to monitor 912 the integrity of the distributed logical linked list and the state of the associated deployment servers.

The preservation of network boot services imparted by the present invention can have a real and positive impact on overall system dependency and availability. In certain embodiments, the present invention improves uptime, application availability, and real time business performance, all of which results in driving lower the total cost of ownership. In addition to improving utilization of system resources, embodiments of the present invention removes the risk of a single point of failure, and allows a system a method to maintain the integrity of a list of network boot servers, as well as any other type of servers.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for autonomously preserving high-availability network boot services, the apparatus comprising:
a monitor module configured to actively monitor a distributed logical linked list;
a detection module coupled to the monitor module, the detection module configured to detect a variation in a distributed logical linked list configuration; and
a substitution module in communication with the detection module, the substitution module configured to substitute a network boot service of a failed element of the distributed logical linked list.

2. The apparatus of claim 1, further comprising a configuration module coupled to the monitor module, the configuration module configured to configure the distributed logical linked list and to reconfigure the distributed logical linked list in response to receiving a signal from the detection module.

3. The apparatus of claim 2, further comprising a validation module coupled to the configuration module, the validation module configured to validate a server contact list and/or a master table associated with the distributed logical linked list.

4. The apparatus of claim 2, further comprising a deletion module coupled to the configuration module, the deletion module configured to delete a server contact list and/or a master table associated with the distributed logical linked list.

5. The apparatus of claim 2, further comprising an update module coupled to the configuration module, the update module configured to update a server contact list and/or a master table associated with the distributed logical linked list.

6. The apparatus of claim 2, further comprising an acknowledgement module coupled to the configuration module, the acknowledgement module configured to acknowledge a modification of a server contact list and/or a master table associated with the distributed logical linked list.

7. The apparatus of claim 1, further comprising a replication module coupled to the monitor module, the replication module configured to replicate an active management resource associated with a master deployment server.

8. The apparatus of claim 1, wherein active monitoring comprises periodically validating a server contact list and/or a master table associated with the distributed logical linked list within a predefined heartbeat interval.

9. The apparatus of claim 1, further comprising an activation module configured to activate a management function associated with a master deployment server and/or to activate a network boot service associated with a deployment server.

10. The apparatus of claim 1, further comprising a promotion module configured to promote a secondary deployment server to a primary backup deployment server and/or to promote the primary backup deployment server to a master deployment server.

11. A system for autonomously preserving high-availability network boot services, the system comprising:
a master deployment server configured to manage a process to preserve a service of a network boot server;
a primary backup deployment server coupled to the master deployment server, the primary backup deployment server configured to replicate a management function of the master deployment server;
a secondary deployment server coupled to the primary backup deployment server, the secondary deployment server configured to serve a network boot service to a plurality of connected computer clients; and
a service preservation utility in communication with the master deployment server, the service preservation utility configured to autonomously process operations to preserve the network boot service and maintain a distributed logical linked list.

12. The system of claim 11, wherein the service preservation utility comprises:
a monitor module configured to actively monitor a distributed logical linked list;
a detection module coupled to the monitor module, the detection module configured to detect a variation in a distributed logical linked list configuration; and
a substitution module in communication with the detection module, the substitution module configured to substitute a network boot service of a failed element of the distributed logical linked list.

13. The system of claim 11, wherein the master deployment server, the primary backup deployment server and/or the secondary deployment server comprises:
a preclusion indicator configured to indicate a preclusion of promoting a deployment server as a master deployment server; and
a priority indicator configured to indicate a priority to position a deployment server higher or lower in a distributed logical linked list.

14. The system of claim 11, wherein the master deployment server comprises an active master table configured to record all members that are current elements of the distributed logical linked list.

15. The system of claim 14, wherein the primary backup deployment server comprises an inactive master table configured to replicate all current elements of the active master table.

16. The system of claim 11, wherein a deployment server comprises a server contact list configured to record an element directly upstream and an element directly downstream from the deployment server on the distributed logical linked list.

17. A signal bearing medium tangibly embodying a program of machine-readable instructions executable by a digital processing apparatus to perform operations for autonomously preserving high-availability network boot services, the operations comprising:
autonomously monitoring a distributed logical linked list;
detecting a variation in the distributed logical linked list; and
substituting a failed element of the distributed logical linked list.

18. The signal bearing medium of claim 17, wherein the operations further comprise configuring the distributed logical linked list and reconfiguring the distributed logical linked list in response to receiving a signal from the detection module.

19. The signal bearing medium of claim 17, wherein the operations further comprise replicating an active management resource associated with a master deployment server.

20. A method for deploying computing infrastructure, comprising integrating computer readable code into a computing system, wherein the code in combination with the computing system is capable of performing the following:
determining a client hardware configuration comprises:
a distributed logical linked list of a plurality network boot servers;
a master deployment server configured to manage a process to preserve the service of the plurality of network boot servers and maintain a master table associated with the distributed logical linked list;
a primary backup deployment server configured to replicate all management functions of the master deployment server; and
a secondary deployment server configured to serve network boot services to a plurality of connected computer clients and maintain a server contact list associated with the distributed logical linked list;
executing a service preservation process for the hardware configuration configured to:
monitor a distributed logical linked list;
detect a variation in the distributed logical linked list;
substitute a failed element of the distributed logical linked list; and
upgrading a system network to provide a secure and high-availability deployment management network configured to:
prevent a rogue server from linking and connecting to the distributed logical linked list;
prevent an rogue server from providing network boot service to a client attached to the system network; and
prevent booting of a rogue operating system or a rogue image into the system network.
